(19) United States
(12) Patent Application Publication
(10) Pub. No.: US 2026/0340801 A1
(43) Pub. Date: Oct. 29, 2026

(54) AI-BASED STENT INSPECTION

(71) Applicant: BIOTRONIK AG, Buelach (CH)

(72) Inventors: Christian Schwarz, Rostock (DE); Abeer Asif, Rostock (DE)

(21) Appl. No.: 19/119,663

(22) PCT Filed: Nov. 27, 2023
(86) PCT No.: PCT/EP2023/083089

§ 371 Date: Apr. 9, 2025

(30) Foreign Application Priority Data
Dec. 7, 2022 (EP) 22211854.9

(51) Int. Cl. G06T 7/00; G06T 7/70; G06V 10/764; G06V 10/774; G06V 10/776; G06V 10/82; G06V 20/40

(52) U.S. Cl. CPC G06T 7/0004; G06T 7/70; G06V 10/764; G06V 10/774; G06V 10/776; G06V 10/82; G06T 2207/10016; G06T 2207/20081; G06T 2207/20084; G06T 2207/30108; G06V 20/40; G06V 2201/06

(57) ABSTRACT

A computer-implemented method for training an artificial intelligence (AI) engine for classifying a stent. A plurality of AI engine training data sets are provided. Each AI engine training data set includes a training image data set associated with a stent and label data associated with the training image data set. The label data indicates at least one of a plurality of predetermined classes. The AI engine assigns at least one of the plurality of predetermined classes to each training image data set. The AI engine is adjusted based at least in part on a comparison, for each of the plurality of AI engine training data sets, of the at least one class assigned to the training image data set of the AI engine training data set with the label data of the AI engine training data set.

### PRIORITY CLAIM

This application is a 35 U.S.C. 371 US National Phase and claims priority under 35 U.S.C. § 119, 35 U.S.C. 365 (b) and all applicable statutes and treaties from prior PCT Application PCT/EP2023/083089, which was filed Nov. 27, 2023, which application claimed priority from EP Application Serial No. 22211854.9, which was filed Dec. 7, 2022.

### FIELD OF THE INVENTION

A field of the invention concerns inspection systems, and particularly systems that inspect manufactured stents.

### BACKGROUND

Changing life circumstances (such as, e.g., stress, an increased consumption of unhealthy food, smoking, etc.) over the recent years have led to an increase of coronary and/or artery related diseases. These diseases can lead to hazardous effects on a health state of a patient (e.g., to a stenosis in a blood vessel of a patient) and can in some cases even deteriorate potentially leading to an increased mortality of affected patients.

To avoid life-threatening circumstances, it can be crucial to diagnose respective diseases during an early stage of the disease and/or to allow a curing of the disease wherein the risk for the patient shall preferably be as low as possible.

By way of example, diagnosed stenosis can in many cases at least partially be cured by a minimally invasive delivery of a stent (e.g., by a dedicated catheter) to avoid a further occlusion of a certain blood vessel and/or to at least partially remove a prevalent occlusion. A stent can be understood as, e.g., a tubular shaped medical device including a wire mesh. The wire mesh can be adapted to be radially compressed (e.g., to ensure that a stent can fit into an inner lumen of a respective catheter) and can be expandable (e.g., in a radial direction) when the stent leaves a catheter at a location of an occlusion. A successfully delivered stent can then, e.g., prevent the patient from (further) occlusions of blood vessels (e.g., by radially dilating a stenosis) which can, e g., lead to heart attacks and/or other life-threatening complications. The importance of state-of-the-art stents can thus not be overestimated.

Since stringent demands are typically applied to a stent acting as a medical device, the characterization of a stent after its manufacturing is crucial to detect any anomalies of a stent prior to its insertion into the body of a patient which can otherwise lead to unsatisfying properties of the stent which can, e.g., affect its functioning (e.g., the expansion properties of the stent can in some circumstances not be satisfying).

Approaches known in the art for the inspection of stents are based on a visual inspection of a stent, e.g., based on known image processing techniques and analysis methods, which can be traced back to numerical values, e.g., based at least in part on a counting of pixels, determination of gray scale values (e.g., to determine edges), etc., or e.g., by comparison with reference images.

For inspecting a stent, the stent typically has to be pushed onto a mandrel, because the measuring procedures applied in the art can be extremely precise (and at least partially based on a calibration) such that focusing of the stent is necessary and even slight movements of the stent within the characterization environment can disturb the image acquisition and evaluation.

In this case, images of a stent used for the purpose of inspecting the stent are often acquired with a line scan camera or a comparable sensor (e.g., confocal sensors). The resulting images (mostly gray scale, seldom RGB which are nevertheless often processed as gray scale images) are then analyzed for deviations in the gray scale values for certain contiguous pixel areas. For this purpose, different parameters have to be set, e.g., a minimum and maximum gray scale value, pixel array, dilatation and erosion sizes, etc. and mostly for different error sizes.

A typical disadvantage associated with said approach is that many defects are not found at all. As a consequence, they cannot be detected and further analyzed in a running production. Another disadvantage is that the aforementioned tests require a calibration prior to executing the respective measuring tests (as outlined above).

Therefore, there is still a demand to further improve the inspection of stents.

### SUMMARY OF THE INVENTION

A preferred embodiment provides a computer-implemented method for training an artificial intelligence (AI) engine for classifying a stent. A plurality of AI engine training data sets are provided. Each AI engine training data set includes a training image data set associated with a stent and label data associated with the training image data set, The label data indicates at least one of a plurality of predetermined classes. The training image data set of at least a subset of the AI engine training data set is based at least in part on a decoded image data set output by an autoencoder trained for detecting a defect of the stent. The AI engine assigns at least one of the plurality of predetermined classes to each training image data set. The AI engine is adjusted based at least in part on a comparison, for each of the plurality of AI engine training data sets, of the at least one class assigned to the training image data set of the AI engine training data set with the label data of the AI engine training data set. The autoencoder is trained based at least on the following steps. Providing a plurality of autoencoder training data sets, wherein each autoencoder training data set includes a training input image data set associated with a stent, wherein the providing includes altering raw image data associated with the stent. Providing, by the autoencoder, a decoded image data set output based on each training input image data set. Adjusting the autoencoder based at least in part on the decoded image data set outputs, wherein the adjusting includes comparing the decoded image data set outputs with the corresponding raw image data.

### BRIEF DESCRIPTION OF THE DRAWINGS

The following figures are provided to support the understanding of the present invention:

FIG. 1: Illustration of an exemplary stent inspection method according to an aspect of the present invention;

FIG. 2: Illustration of an exemplary method for classifying at least an area of a test image data set;

FIG. 3: Illustration of exemplary autoencoder training data sets usable to train an exemplary denoising autoencoder;

FIG. 4: Illustration of an exemplary multiclass identifier according to an aspect of the present invention;

FIGS. 5A-5B: Illustration of an exemplary live inspection of a stent according to an aspect of the present invention;

FIG. 6: Illustration of an exemplary stent inspection device;

FIG. 7: Illustration of an exemplary movement of a stent in the field of view of a camera of a stent inspection device according to an aspect of the present invention;

FIG. 8: Illustration of an exemplary segmentation of an image captured by a camera of a stent inspection device according to an aspect of the present invention;

FIG. 9: Illustration of an exemplary segmentation of an image captured by a camera of a stent inspection device according to an aspect of the present invention;

FIGS. 10A-10C: Illustration of an exemplary magnification of an area of interest of a stent according to an aspect of the present invention;

FIGS. 11A-11D: Illustration of exemplary training image data sets used for training an AI engine for classifying a stent type according to an aspect of the present invention;

FIG. 12: Illustration of an exemplary architecture of a multi-class classifier usable for classifying a stent type according to an aspect of the present invention;

FIGS. 13A-13H: Illustration of exemplary autoencoder training data sets usable for training a denoising autoencoder for classifying a defect type according to an aspect of the present invention;

FIG. 14: Illustration of an exemplary architecture of a denoising autoencoder for classifying a defect type according to an aspect of the present invention;

FIGS. 15A-15R: Illustration of exemplary training data sets usable for training multi-class classifier for classifying a defect type according to an aspect of the present invention;

FIGS. 16A-16H: Illustration of exemplary training data set augmentation techniques for increasing the available training data usable for training a multiclass classifier according to an aspect of the present invention;

FIG. 17: Illustration of an exemplary architecture of a multiclass identifier according to an aspect of the present invention.

### DETAILED DESCRIPTION OF THE PREFERRED EMBODIMENTS

Drawbacks of prior stent inspection methods and systems can at least partially be overcome by a first aspect of the present invention which relates to a computer-implemented method for training an artificial intelligence (AI) engine for classifying a stent. The method can include providing a plurality of AI engine training data sets, wherein each AI engine training data set includes a training image data set associated with a stent and label data associated with the training image data set, wherein the label data can indicate at least one of a plurality of predetermined classes (e.g., associated with the stent), wherein the training image data set of at least a subset of the AI engine training data set is based at least in part on a decoded image data set output by an autoencoder trained for detecting a defect of the stent. The method can further include assigning, by the AI engine, at least one of the plurality of predetermined classes to each training image data set and adjusting the AI engine based at least in part on a comparison, for each of the plurality of AI engine training data sets, of the at least one class assigned to the training image data set of the AI engine training data set with the label data of the AI engine training data set. Further, the method can include training the autoencoder based at least on the following steps: providing a plurality of autoencoder training data sets, wherein each autoencoder training data set includes a training input image data set associated with a stent, wherein the providing includes altering raw image data associated with the stent; providing, by the autoencoder, a decoded image data set output based on each training input image data set; and adjusting the autoencoder based at least in part on the decoded image data set outputs, wherein the adjusting includes comparing the decoded image data set outputs with the corresponding raw image data.

The aforementioned computer-implemented method can allow the training of an AI engine such that the trained AI engine correctly assigns classes to certain training image sets. Such an AI engine can allow an AI-based and thus autonomous inspection of stents and the association of the stents to be inspected to at least one predetermined class. Based at least in part on the AI support, no manual learning and/or instruction of workers is required anymore to inspect a stent and assign a respective stent to at least one predetermined class. This can advantageously contribute to a more reliable association of a stent with at least one predetermined class and can contribute to a more cost-effective quality control of an output of a manufacturing line of stents.

The AI engine can for example be implemented as a neural network including at least one input and at least one output layer and preferably at least one intermediate hidden layer. Each of the layers can be provided with at least one node. The at least one node of each of adjacent layers (as seen from the at least one input layer to the at least one output layer) can be interconnected with each other. Each interconnection can be provided with a weighting coefficient indicating a strength of a relationship of the respective nodes.

The training can preferably be based on supervised learning.

The training image data set included by the AI engine training data set can include at least one image of a whole stent and/or image of a subarea of a stent and can thus only partially depict the stent. The AI engine training data sets can preferably include label data associated with each of the plurality of predetermined classes a trained AI engine is expected to associate with corresponding image data.

Label data can be understood as an indicator indicating an affiliation of a certain training image data set to at least one of the plurality of predetermined classes. In an example, label data can label a certain training image data set as class “A” and “B” indicating that the respective training image data set can be a representative of (predetermined) classes A and B.

The assigning of the at least one class of the plurality of predetermined classes to each training image data set can include determining a probability indicating a likelihood with which a certain training image data set can be seen as a representative of at least one class of the plurality of predetermined classes. In an example, if three classes A, B and C are predetermined, the determining of the probability can allow the assessment that the likelihood that a certain training image data set is a representative of class A is, e.g., 95%, whereas the respective likelihood that the training image data set is a representative of class B is 3% and whereas the respective likelihood that the training image data set is a representative of class C is 2%. The assigning can further include comparing the one or more determined probabilities with a (predetermined) threshold. In some examples, a training image data set can, e.g., be assigned to the class associated with a maximum probability value and/or to a plurality of classes, each class associated with a maximum probability in a subgroup of classes.

For example, the plurality of predetermined classes includes at least one stent type and/or at least one defect type and/or at least one posture indicator. For each (training) image data set, a stent type, (optionally) a defect type and/or a posture indicator can be assigned.

The stent type can be understood as a product type of a stent manufacturer defined by at least one characteristic design element of a stent (e.g., a dimensioning of a stent, a diameter of a stent, a shape of a stent, a structural element (e.g., a mesh pattern of the stent), etc.).

The defect type of a stent can be understood as an anomaly in the stent, e.g., caused by an erroneous manufacturing step, which can disadvantageously affect at least one stent property when the stent is used in a medical application.

The posture indicator can be associated with a position and/or an orientation of the stent relative to means for inspecting a stent.

A posture indicator can be understood as at least one parameter indicating a location of a stent in a stent inspection device (e.g., relative to an image capturing device and/or relative to at least one other fixpoint of the stent inspection device). The location of a stent in a stent inspection device can, e.g., be expressed by three coordinates (e.g., X, Y and Z) relative to a fixpoint of the stent inspection device.

Additionally or alternatively, the posture indicator can indicate an orientation of a stent relative to the same or another fix point of a stent inspection device. The orientation can, e.g., be expressed by at least one angle relative to the fix point of stent inspection device. The at least one angle can include one or more of a roll angle, a pitch angle and/or a yaw angle.

By configuring the predetermined classes such that they can include one or more of the aforementioned stent characteristics, a detailed automatized inspection according to key characteristics of a stent can be supported. The posture indicator can advantageously contribute to a determination whether a stent is properly placed in a stent inspection device. Based thereon, it can be ensured that a potential defect in a stent can not be overlooked or mimicked as a result of an erroneously placed stent within the stent inspection device. As a result, an automized detection of a stent type, a stent orientation and a potential defect of a stent can be facilitated without external input, subsequently and preferably with the same inspection device. This can advantageously contribute to an efficient inspection throughput (e.g., in terms of the number of stents inspected per hour, per day, etc.) and can decrease the overall costs associated with a stent inspection.

The comparison can include determining a difference between the assigned at least one class of the plurality of predetermined classes and corresponding label data (which can indicate a factual affiliation of an image data set with at least one of the plurality of predetermined classes). The at least one weighting coefficient of the neural network can be adjusted based at least in part on the determined difference such that, if the computer-implemented method is executed iteratively, a difference determined in said subsequent iteration step can preferably decrease as compared to a preceding iteration step. In some exemplary implementations, the adjusting can be based at least in part on at least one of linear regression, gradient descent and/or logistic regression and/or any other suitable algorithms.

An arrangement of an AI-autoencoder prior to the aforementioned AI engine can facilitate a two-step process of detecting a defect of a stent: a localization of a potential location of a defect of a stent (e.g. by the autoencoder) and a subsequent characterization of the potentially identified defect to elicit which kind of defect the respective stent can include (e.g. assigning the correct defect class).

The detecting of a defect of a stent by an autoencoder can e.g. be understood as providing an indication that a certain training image data set can include a defect, i.e., providing an indication that a stent is defective, and possibly indicating a defect position and/or region in the image data. The detecting can further include determining a discrepancy between a decoded image data set output of the autoencoder and an input image data set provided to the autoencoder and preferably indicating a determined discrepancy to an operator of the computer-implemented method (e.g., to an operator, etc.).

The autoencoder can be based on a pre-trained AI model. By the training, the autoencoder can be trained to preferably encode a training input image data set and subsequently reconstruct the encoded input image data set such that the training input image data set (e.g., including an anomaly) originally supplied to the autoencoder can be cleaned, i.e., the anomaly can be removed. This can facilitate a detection and location of potential defects of a stent included in a training input image data set provided to the trained autoencoder by generating a difference image between the (training) input image data set and the output of the autoencoder. Regardless of defect position or the portion of the stent shown in the image, the defect can be correctly identified. Since the autoencoder can have been trained to remove any anomalies in the image data set, any difference indicated in the difference image can be associated with a potential defect depicted in the image data set provided to the trained autoencoder. This can facilitate an indication and a subsequent location of a potential defect in a training input image data set which can further be processed as outlined further below.

The providing includes altering raw image data associated with the stent. For example, an anomaly can be added artificially. The adjusting can include comparing the decoded image data set outputs with the corresponding raw image data. The autoencoder can thus be trained to reproduce the raw image data (i.e. a defect-free portion of a stent) based on image data including an anomaly.

In other words, the training input image data set provided to the autoencoder for training the autoencoder can not ab initio include a representation of a defect of the stent. The training input image data set provided to the autoencoder can be preprocessed, e.g., by artificially adding an anomaly (e.g., a defect of the stent). The training input image data set including the artificially added anomaly can be provided to the autoencoder as autoencoder training data. The underlying raw image data set (without the artificially added anomaly) can be provided to the autoencoder as label data. The training of the autoencoder can include learning how to remove an anomaly included in the training input image data set provided to the autoencoder which has artificially been provided with an anomaly.

The method can further include preprocessing and/or augmenting the training input image data set of at least a portion of the autoencoder training data set prior to the step of providing a plurality of autoencoder training data sets. This can generally include aspects as outlined herein with reference to training the AI engine.

The computer-implemented method can further include preprocessing and/or augmenting the training image data sets of at least a portion of the AI engine training data sets prior to the step of assigning at least one of the plurality of predetermined classes to each training image data set.

The preprocessing can include one or more of adapting a color of a training image data set (e.g., converting an RGB image into a greyscale or black and white image), increasing/decreasing a contrast ratio of the training image data set and/or cropping a captured image to a certain image size and/or upscaling/downscaling the resolution of the image, etc. The preprocessing further can include artificially adding anomalies to at least one training image data set included by the training data, e.g. such as to mimic a defect.

Augmenting of the training image data set can be understood as copying at least one of the training image data sets included in the AI training data set and altering the copied image data set. The altering can, e.g., include one or more of adding brightness to the copied image data set and/or horizontally/vertically flipping/mirroring of the copied image data set, etc.

By preprocessing and/or augmenting at least one training image data set included in the at least one AI training data set, the total number of AI training data sets can (artificially) be increased. This can improve the training of the AI engine and can thus improve the accuracy of the predictions made by the trained AI engine (e.g., a correct assignment of a trained image data set to at least one predefined class).

Preferably, the invention relates to a computer-implemented method for training a plurality of AI engines for classifying a stent. The method can include providing a different plurality of AI engine training data sets to each AI engine, wherein each AI engine training data set includes a training image data set associated with a stent and label data associated with the training image data set, wherein the label data indicates at least one of a plurality of predetermined classes. The method can further include assigning, by each of the AI engine, at least one of the plurality of predetermined classes to each training image data set, and adjusting each of the AI engine based at least in part on a comparison, for each of the different plurality of AI engine training data sets, of the at least one class assigned to the training image data set of the AI engine training data set with the label data of the AI engine training data set.

The different plurality of AI engine training data sets can be disjunct AI engine training data sets.

According to the invention, all embodiments referring to the computer-implemented method for training an AI engine for classifying a stent as outlined herein are also applicable, mutatis mutandis, to the computer-implemented method for training a plurality of AI engines for classifying a stent.

In some examples, the step of assigning includes assigning at least one of the plurality of predetermined classes including at least one stent type to each training image data set by a first AI engine and/or assigning at least one of the plurality of predetermined classes including at least one defect type to each training image data set by a second AI engine, and/or assigning at least one of the plurality of predetermined classes including at least one posture indicator to each training image data set by a third AI engine.

A second aspect of the invention relates to a computer-implemented method for classifying a stent. The method can include receiving, by an AI engine trained as outlined herein, a test image data set associated with a stent. The method can further include determining, by the AI engine, an assignment value indicating a relationship between the test image data set and at least one of the plurality of predetermined classes.

The assignment value can be understood as a probability indicating a likelihood with which a certain test image data set, provided to the trained AI engine, can be seen as a representative of at least one class of the plurality of predetermined classes. The determining of the assignment value can be implemented as outlined with respect to the training of the AI engine, herein.

The computer-implemented method for classifying a stent can further include discriminating the assignment value according to a predetermined threshold. The discriminating can be understood as assigning the test image data set provided to the trained AI engine to at least one (predetermined) class if the assignment value is above a predetermined threshold. In an example, the test image data set can only be associated with at least one class if the assignment value is, e.g., above 90% (or any other suitable value).

The aforementioned classification can be implemented as a sole step of inspecting a stent or can be implemented in addition to a manual inspection, e.g., by an operator. In the latter case, the computer-implemented method can be understood as a support for an operator when inspecting a stent.

In some examples, one test image data set can include one image of at least an area of a stent. In some examples, a test image data set can include more than one image of a same stent. In some examples, the stent can be rotated about its longitudinal axis during inspection. For example, in such cases each individual image can be captured for a different rotation angle of the stent about its longitudinal axis (each individual image of the image data set can thus depict a different area of the stent). In some examples, a test image data set can include more than one picture of the same area of a stent.

This can facilitate an efficient and automized assignment of at least one class of the plurality of predetermined classes to a test image data set without requiring a human input.

The at least one training image data set and/or the test image data set associated with a stent can include at least one video sequence of the stent, e.g., including footage of an entire circumference of the stent and/or along an entire length of the stent.

In some exemplary implementations, the at least one training image data set and/or the test image data set can be configured such that all of the respective images included therein can be transformed into at least one video sequence by subsequently stringing together the respective constituents of the image data sets. In a preferred implementation, 24 images (or 30 images or 60 images or 120 images or 144 images or any other suitable number of images) can be aggregated to one second of video sequence.

The usage of a video sequence can facilitate a continuous and/or autonomous inspection of a stent such that no subareas of a surface of a stent remain uninspected. This can, e.g., be facilitated if the stent is rotated about its longitudinal axis while capturing a video sequence of the stent as it is rotated. The individual images effectively captured by capturing the video sequence can each be processed by the trained AI engine (e.g., as outlined above) and assigned to at least one (predetermined) class. The continuous and/or autonomous inspection of a stent can overcome fatigue and an associated decrease of attention of a human operator over the inspection time. As a result of the fatigue, anomalies in a stent can not be detected to a satisfying extent and faulty stents can thus erroneously be used for diagnostics and or curing applications. However, the present invention can ensure that a stent is continuously inspected at a continuously high level of attention. This can contribute to a more reliable inspection of stents and allows the inspection of more stents per time interval as compared to a conventional, manual inspection of a stent.

The test image data set can be based on decoded output image data of an autoencoder trained as outlined herein.

Based on the decoded output image of the trained autoencoder, a difference image can be calculated between an output of the trained autoencoder and an input image data set (e.g. that on which the decoded output image is based) provided to the autoencoder (e.g., calculated by a pixel-wise subtracting of the decoded output image data from the input image data set or vice versa).

The difference image of the trained autoencoder can preferably include at least one indication of a defect of the stent. The indication of a defect of the stent can relate to at least a portion of the difference image at which the calculated difference exceeds a predetermined threshold. The indication of the defect of the stent can further include defining an area of interest of the difference image wherein the area of interest includes the indication of the defect. In some examples, the area of interest can be defined by, e.g., (pixel) coordinates defining a rectangle including the indication of the defect in the difference image.

In some examples, a method can further include cutting out at least a portion of the input image data set wherein the location of the cut-out is defined by the area of interest associated with the indication of the defect.

By providing the trained AI engine with a test image data set including a cut-out portion of the input image data set provided to the autoencoder, a classification of a previously identified potential defect in the input image data set can be facilitated such that the defect can be classified efficiently.

In other examples, it can also be helpful to provide the AI engine with a test image data set which includes decoded output image data of an autoencoder trained as outlined herein. For example, a defect can thus be removed, facilitating initial classification of the posture and/or type of the stent. In a subsequent step, the defect can then be classified as outlined herein.

In some examples, the test image data set can be disjunct from the AI engine training data set, i.e., training image data sets used for training the AI engine can not be included in the test image data set provided to the trained AI engine used for classifying the provided test image data set. In some examples, the trained AI engine can be configured to assign the same at least one predefined class to the test image data set the AI engine can have been trained on beforehand (and as outlined herein).

By providing the trained AI engine with the test image data set a reliable assignment of one or more of the plurality of predefined classes to the test image data can be facilitated.

The test image data set and/or a video sequence included therein can be obtained in real time.

The usage of real time test image data set and/or video sequences can support a fast inspection of a stent and can support an immediate identification of a positioning or rejection of stents identified as defective. Moreover, a real time inspection of a stent can allow an immediate double checking of a defect, e.g., by an (experienced) operator such that false-positive indications of potentially defective stents can be avoided. This can also support an inspection of an outside area of a stent and/or an inspection of a stent of an inside area of a stent.

Real time test image data set and/or video sequences can be understood as an image and/or a video sequence which is essentially synchronously obtained from an imaging device (e.g., a CCD) camera without the need for an at least temporary buffering of the captured image and/or video sequence.

In some examples, the method can not include a calibration step.

A calibration can be understood as an alignment of a stent to be characterized relative to at least one fixpoint of a stent inspection device such that stents to be inspected are always located at the same location (and/or with a same orientation) and such that the stents to be inspected can always be imaged from a same distance and/or perspective and/or magnification and/or at the same light conditions and/or focusing settings with respect to an imaging device used for capturing the image data as described above.

This complex procedure can ensure that image sets of a stent can be comparable to each other and such that a stent can, e.g., be inspected by counting certain pixels within a certain area to potentially determine a defect.

The absence of the requirement of a calibration can facilitate a simplified and cost-efficient stent inspection. Moreover, the classifying can not require any dedicated measurement steps (e.g., based at least in part on counting pixels, etc.) and can solely rely on the classification performed by the trained AI engine. This can be facilitated as no counting of pixel (areas) to locate and/or characterize, e.g., a defect in a stent, can be required which oftentimes require an alignment of a stent to be characterized relative to an image capture device with a predefined magnification and/or certain fix points of a stent inspection device. Moreover, an association of at least one predefined class to an image data set can directly be performed by the trained AI engine without the requirement of an exhaustive calibration and associated pixel counting based processing steps. Furthermore, the absence of a calibration can further support the usage of a variety of different camera systems (also including digital microscopes and/or microscopes with a camera mount) as the method can not need to be adapted to a certain camera type.

Preferably, the method according to the second aspect of the invention can include receiving, by a plurality of AI engines trained as outlined herein, a test image data set associated with a stent. The method can further include determining, by each of the AI engines, an assignment value indicating a relationship between the test image data set and at least one of the plurality of predetermined classes.

In some examples, the step of determining includes determining, by a first AI engine, an assignment value indicating a relationship between the test image data set and at least one of the plurality of predetermined classes including at least one stent type the first AI engine has been trained with and/or determining, by a second AI engine, an assignment value indicating a relationship between the test image data set and at least one of the plurality of predetermined classes including at least one defect type the second AI engine has been trained with, and/or determining, by a third AI engine, an assignment value indicating a relationship between the test image data set and at least one of the plurality of predetermined classes including at least one posture indicator the third AI engine has been trained with.

A third aspect of the invention relates to an apparatus for inspecting a stent. The apparatus can include means for accommodating and rotating the stent about its longitudinal axis and means for capturing a test image data set associated with the stent. Moreover, the apparatus can include means for executing the method as outlined above.

The means for accommodating and rotating the stent about its longitudinal axis can include two rollers parallel to each other and horizontally (perpendicular to a longitudinal axis of the at least one roller) separated from each other (or more preferably three rollers parallel to each other and horizontally separated from each other) extending along a longitudinal direction which can be oriented parallel to an axis about which the rollers can be rotated clockwise and/or counterclockwise. The rollers can be in contact with the stent such that a rotation of the rollers can cause a rotation of the stent about the longitudinal axis of the stent.

Providing an apparatus for inspecting a stent as outlined above can advantageously contribute to an automized inspection of stents (without the necessity for external input of an operator of the apparatus). This can contribute to a faster and a more reliable inspection of a stent.

The means for capturing test image data can be provided as a line scan camera, a CCD camera, a greyscale camera, a microscope, etc. The means for executing the method will be detailed further below.

A fourth aspect of the invention relates to a data-processing system which can include means for executing the methods as outlined herein.

By way of example, means, or any portion of means, or any combination of means can be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system can execute software.

In some exemplary implementations, the data-processing system can be implemented as a remote entity which can be physically separated from an apparatus for inspecting a stent. The data-processing system can be implemented as a server which can be configured to execute one of the methods as outlined above. In such a case, a centralized and preferably high performance inspection of a stent can be facilitated.

A fifth aspect of the invention relates to a computer program having instructions which when executed cause a computing device or system to perform a method as outlined above.

Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described can be implemented in hardware, software, or any combination thereof. If implemented in software, the functions can be stored on or encoded as one or more instructions or code on a computer-readable medium. Computer-readable media includes computer storage media. Storage media can be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Possible embodiments of the present invention will be described in the following. For brevity, only a few embodiments can be described. The skilled person will recognize that the specific features described with reference to these embodiments can be modified and combined differently and that individual features can also be omitted if they are not essential. The general explanations in the sections above will also be valid for the following more detailed explanations.

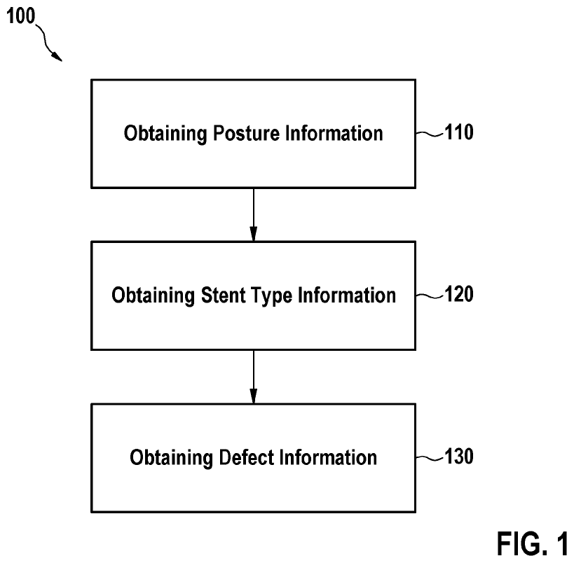

FIG. 1 depicts an exemplary stent inspection method 100 according to an aspect of the present invention which can be carried out as at least a three-step method.

The method 100 can preferably be initiated by obtaining 110 posture information concerning a stent to be investigated, wherein the posture information can be obtained as described herein. The method 100 can further include obtaining 120 stent type information. The stent type information can be obtained as described herein. The method 100 can further include obtaining 130 defect information (to be understood as a qualitative inspection of the respective stent). The defect information can be obtained as described herein.

It is noted that the aforementioned order of steps 110-130 is only given by way of example and that any other ordering of steps 110-130 can also be possible. In some examples, it can also be possible that one or more of steps 110-130 can be omitted.

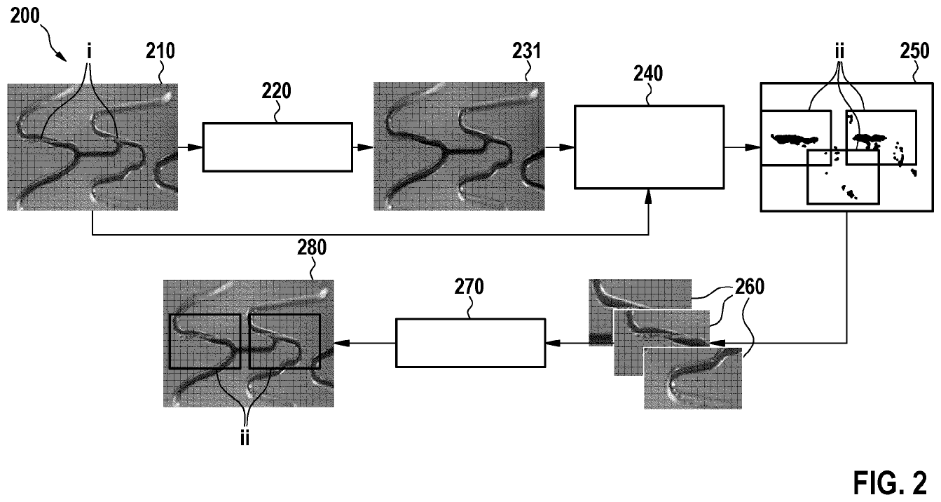

FIG. 2 exemplarily shows a method for classifying 200 an image data set 210 according to an aspect of the present invention.

Image data set 210 can include at least one image (e.g., a photograph) of at least an area of a stent to be inspected or the entire stent (or portions of several stents, etc.). At least one image of the input image data set 210 can include an anomaly i. Anomaly i can be a defect of a stent and/or noise (e.g., any kind of anomaly which is unintentionally deposited on a stent).

Image data set 210 can be provided as an input image data set to autoencoder 220 which can generally be implemented as described herein, e.g., as a denoising autoencoder. Autoencoder 220 can be trained to remove an anomaly which can be present in the input image data set 210. Autoencoder 220 can then provide a decoded image data output 230 which can be based on input image data set 210 wherein any anomalies potentially present in the input image data set 210 can have been removed.

Both the input image data set 210 and the decoded image data output 230 can be provided to a difference and threshold evaluation unit 240. Difference and threshold evaluation unit 240 can determine a difference between the input image data set 210 and the decoded image data output 230. Any differences which can have been determined by difference and threshold evaluation unit 240 can be seen as an indication for the prevalence of an anomaly i. However, in some cases also photographic anomalies (e.g., light reflections, etc.) and/or electronic noise caused by an image capturing device can also be removed by autoencoder 220 which can be understood as noise but not as a defect of a stent. In some examples, a potentially identified difference is only considered as a defect of a stent if the determined difference exceeds a certain predefined threshold. In an example, a difference is only considered a defect if the potential defect is larger than a certain predefined area extending across the stent and/or if the difference exceeds a certain number of greyscale units, etc.

For the sake of completeness, it is further emphasized that the aforementioned steps can also be used to train the autoencoder 220. In said case, input image data set 220 can be replaced by a training input image data set (not shown in FIG. 2) used for training the autoencoder 220. If the aforementioned steps are applied for training the autoencoder 220, the autoencoder 220 can be regarded as trained if the difference image 230 240 does not exhibit any pronounced areas, i.e., an error-free input image data set can then be equal to the decoded image data output 230 (neglecting computational artifacts such as noise). As outlined herein, however, also image data sets with errors can be used for training.

As a result of the aforementioned discrimination procedure, a discriminated threshold image 250 can be obtained. The discriminated threshold image 250 can include respective regions of interest ii in which the difference between the test image set 210 and the decoded output 230 can exceed a certain threshold.

Said regions of interest ii can be cropped out of the input image data set 210 and can further each be treated as corresponding test image data sets 260, wherein the at least one test image data set 260 can correspond to one region of interest ii.

The at least one test image data set 260 can further be provided to a trained AI engine 270, i.e. an AI classifier 270, as described herein. The trained AI engine 270 can preferably include a classifier trained to assign at least one of a plurality of predefined classes to each of the test image data sets 260.

The trained AI engine 270 can be implemented as a multiclass classifier as further described herein. In some examples, AI engine 270 can have been trained according to a (predefined) defect catalog (including one or more predetermined classes) such that the AI engine 270 can be capable of assigning a certain input image data set 210 to at least one of the predetermined classes.

The defect catalog can be based at least in part on manual one or more stent inspections by an operator in the past. The defect catalog can include one or more images of a certain defect and an assignment to one or more of the predefined classes (e.g., defect classes).

Based at least in part on the output of the trained AI engine 270, an output image data set 280 can be provided wherein potential defects have successfully been located and wherein the located defects have further been classified.

It is noted that, in some examples, autoencoder 220 can be part of AI engine 270.

Method 200 can be adapted to be executable in fully automatic manner and/or can at least in part be executed manually (e.g., by an operator). In some examples, the autoencoder and the steps associated therewith can be omitted. For example, image data 210 can be provided to AI engine 270 directly.

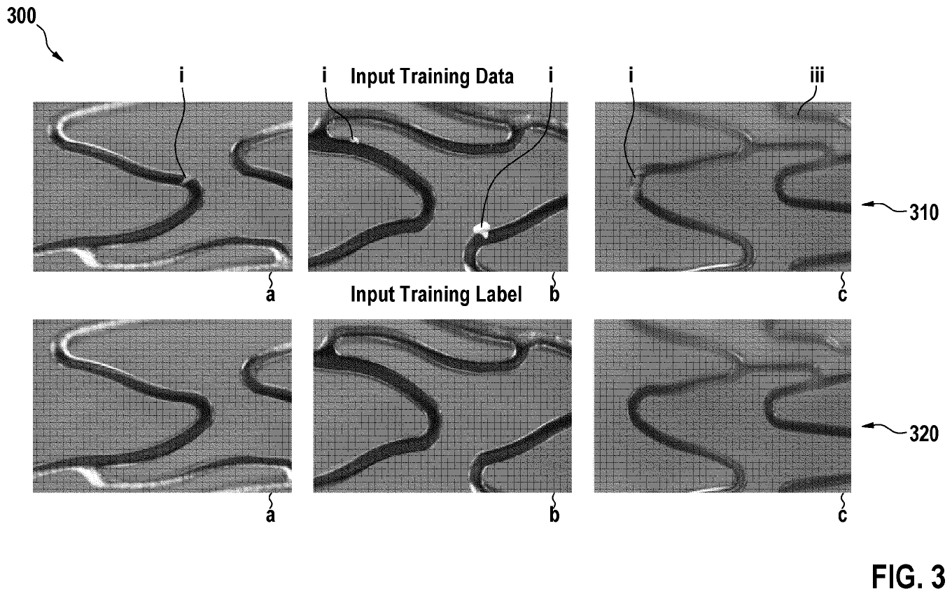

FIG. 3 exemplary shows an image data set 300 which can be used for training the denoising autoencoder 220. The training of the denoising autoencoder 220 can for example be based on supervised learning.

The first row of FIG. 3, including three exemplary images a, b, c, depict potential training input image data sets 310 which can be fed into the denoising autoencoder 220 to be trained.

Training input image data 310 can depict at least an area of a stent. Training input image data sets 310 can include one or more anomalies i such as, e.g., noise and/or a defect of a stent. The noise and/or the defect can correspond to real noise (e.g., a deposited noise particle and/or a real defect) and/or can have been artificially added to the image of a respective stent area.

The second row of FIG. 3, including three exemplary images a, b, c, depicts exemplary autoencoder label data sets 320. Autoencoder label data 320 can be understood as a desired target (image) to be reproduced/output by the denoising autoencoder 220. More specifically, if image a of the training input image data 310 is provided to the denoising autoencoder 320 to be trained, the denoising autoencoder 220 can be challenged to reproduce an image of the autoencoder label data set 320. This effectively includes the step of removing an anomaly i present in image a of the training input image data 310 (that can have been added artificially to the corresponding label data set 320).

In analogy, image b of the training input image data 310, provided to the denoising autoencoder 220, can be transformed into image b of the autoencoder label data set 320, effectively removing noise and/or anomaly i present in image b of the training input data set 321. Similarly, image c of the training input image data 310, provided to the denoising autoencoder 220, can be transformed into image c of the autoencoder label data 320, effectively removing noise and/or anomaly i (and/or a blurry/out of focus region of a stent iii) present in image c of the training input image data 310.

By said training process of the denoising autoencoder 220, the denoising autoencoder 220 can effectively learn to remove noise and/or an anomaly from an image provided as an input image data set to the denoising autoencoder 220. Based on the output image and the corresponding input image (e.g. by a comparison and thresholding as outlined herein) defective/anomalous areas can thus be identified, without having to know stent type, portion of the stent within the image, posture of the stent within the image, etc.

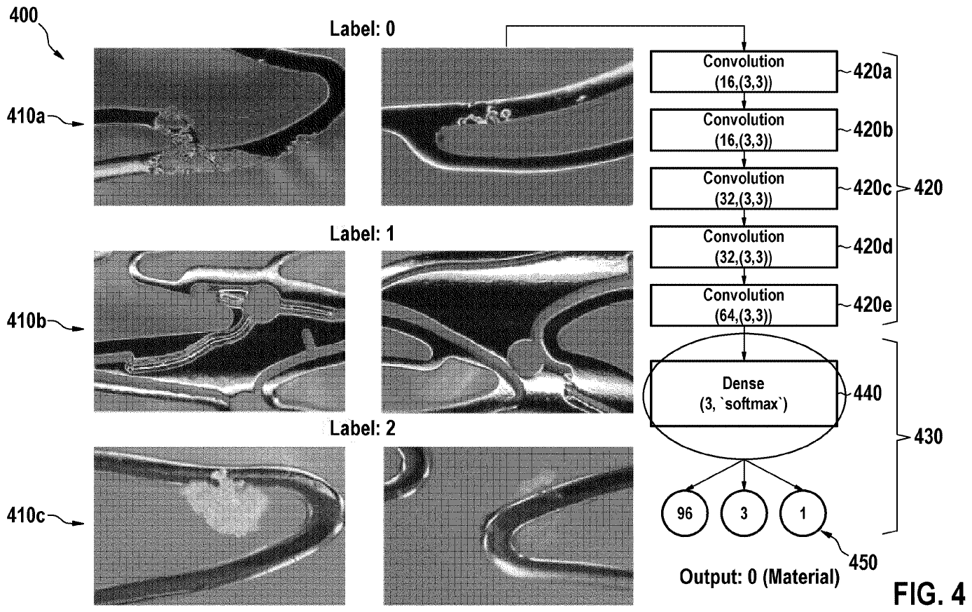

FIG. 4 exemplary depicts a multi-class classifier 400 according to an aspect of the present invention. The exemplary multi-class classifier 400 can have been trained to assign one of three exemplary predetermined classes 0, 1 and 2 to a test image data set provided to the multi-class classifier 400.

For the following exemplary discussion, three exemplary image data sets 410a-410c can be considered: Exemplary image data set 410a includes two images including a defect associated with class 0, wherein class 0 can be associated with stent defects arising from splintered and/or broken off portions of a stent. Exemplary image data set 410b includes two images including a defect associated with class 1, wherein class 1 can be associated with a stent defect arising from a wrong geometry of at least a portion of a structure of a stent. Exemplary image data set 410c includes two images including a defect associated with class 2, wherein class 2 can be associated with a stent defect arising from dust particles residing on at least a portion of a stent.

The images of image data sets 410a, 410b and/or 410c can be provided to the multi-class classifier 400 which includes a feature extractor 420 and classifier 430, wherein the classifier 430 is arranged subsequent to the feature extractor 420.

In the depicted exemplary implementation, feature extractor 420 includes five convolution layers 420a-420e, wherein a first convolution layer 420a can be configured to apply 16 filters to the respective test image data set provided to feature extractor 420. The first convolution layer 420a can further be configured to apply a 3×3 filter/kernel to the image data set provided to the feature extractor 420. In the exemplary implementation of the feature extractor 420, an output of the first convolution layer 420a can be provided to a second convolutional layer 420b which can exemplarily apply 16 filters to the output of the first convolution layer 320a with a filter of size 3×3. In analogy to the first convolutional layer 420a and the second convolutional layer 420b, the third convolutional layer 420c can be configured to apply 32 filter of size 3×3, the fourth convolutional layer 320d can be configured to apply 32 filters of size 3×3, the fifth convolutional layer 320e can be configured to apply 64 filters of size 3×3.

The output of the fifth convolutional layer 420e is then provided to dense layer 440. Dense layer 440 can be configured to apply an activation function of type “softmax” (with three output classes) to the input of the dense layer 440. The output dense layer calculates the last convolutional layer to a vector in the size of number of trained classes. As a result, “softmax” can determine a probability for each of the three predetermined classes indicating a likelihood 450 with which the image data set provided to the multi-class classifier 400 can be a representative of each of the three predetermined classes.

In some exemplary implementations, the calculated probabilities can further be provided to a discriminator for making a final decision to which of the three predetermined classes an image data set provided to the multi-class classifier 400 can be associated with. The assignment can, e.g., be based on choosing the class, which was assigned the highest probability value, e.g., class 0 with a probability of 96% as depicted in FIG. 4.

The classifier 400 can be based at least in part on, e.g., one of ResNet-50, VGG-16 (Visual Geometry Group), DenseNet or any other suitable classifier.

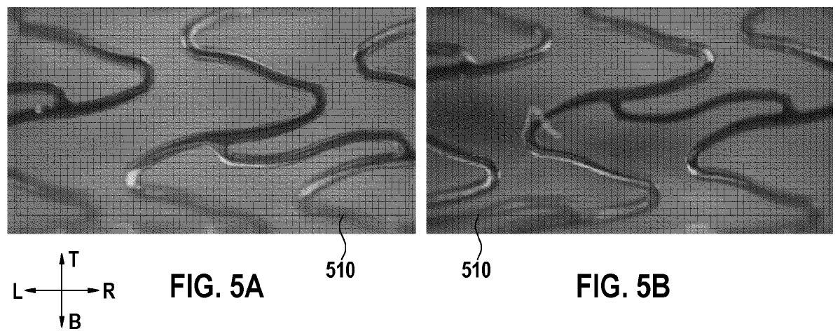

FIGS. 5A and 5B exemplarily show a live inspection of a stent. In some exemplary implementations a stent to be inspected (and classified) can, e.g., be moved within a field of view 510 of an image capture device (e.g., a camera). The stent can, e.g., be moved from left L to right R (or vice versa) and/or can be moved from top T to bottom B (or vice versa). The field of view 510 can define the area which can be evaluated during a classification process as described in further detail herein.

As depicted in FIGS. 5A and 5B, stent areas not located in the field of view 510 are blurred. This can occur due to curved nature of the stent under inspection. The focus of the image capture device can be set to the field of view 510 (which is thus focused). Due to the curved nature of the stent under inspection, some areas of the stent (visible for the image capture device) can be further apart from the camera than other areas (e.g., focused areas) and can thus lie behind the focus point of the image capture device. Blurred areas (e.g., areas outside the field of view 510) can in some examples not be taken into account during stent inspection.

In the following, an exemplary positioning model for determining a location and/or orientation of a stent in a stent inspection device can be explained.

For an automatic stent inspection using artificial intelligence, according to aspects outlined herein, it can be necessary to detect the beginning and the end of the stent to be inspected. The stent inspection device can need information on where to start with the inspection, where to change the direction of movement of a stent (e.g., a rotation of the stent about its longitudinal axis) and information on focus settings to, e.g., switch from capturing an outer stent surface to capturing an inner stent surface, and to recognize further stents on a stent inspection device, etc.

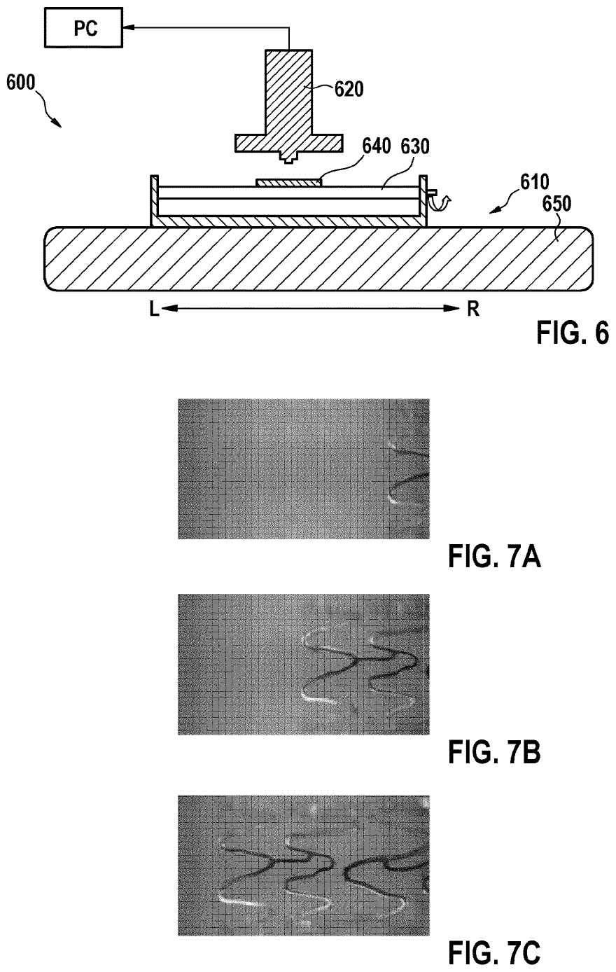

FIGS. 6-9 exemplarily depict various embodiments of classifying a stent such as to obtain location and/or posture information of a stent in a stent inspection device 600.

FIG. 6 depicts an exemplary stent inspection device 600. The stent inspection device 600 can include two parts: a motion system 610 and a camera system 620. The camera system 620 can, e.g., be connected to a PC or any other computing device.

The motion system 610, exemplarily located below the camera system 620, can include means for receiving a stent 630. The means for receiving a stent 630 include at least two (parallel) rotatable rollers configured for receiving a stent 640 therebetween. The at least two rollers can be rotatable about their respective longitudinal axis and can rotate the stent 640. A full evolution of the stent 640 about its longitudinal axis can, e.g., take less than 20 s. The rollers can preferably be provided as white rollers with an annular illumination and/or an alabaster glass diffusor placed between an illumination source and the stent 640.

In some examples, the means for receiving a stent 630 can be placed on a translation stage 650. The translation stage 650 can be adapted to perform a translational (horizontal) movement (e.g., from right to left and vice versa), thereby allowing a horizontal, translational movement of the stent 640, e.g., from right R to left L and under (and preferably within the field of view of) the static camera system 620 mounted above the motion system 610. Therefore, an inspection of the entire surface of the stent 640 can (automatically) be facilitated. More than one roller can be placed in parallel to each other on the translation stage, and the translation stage or camera system can be moved perpendicular to longitudinal axis of the more than one roller.

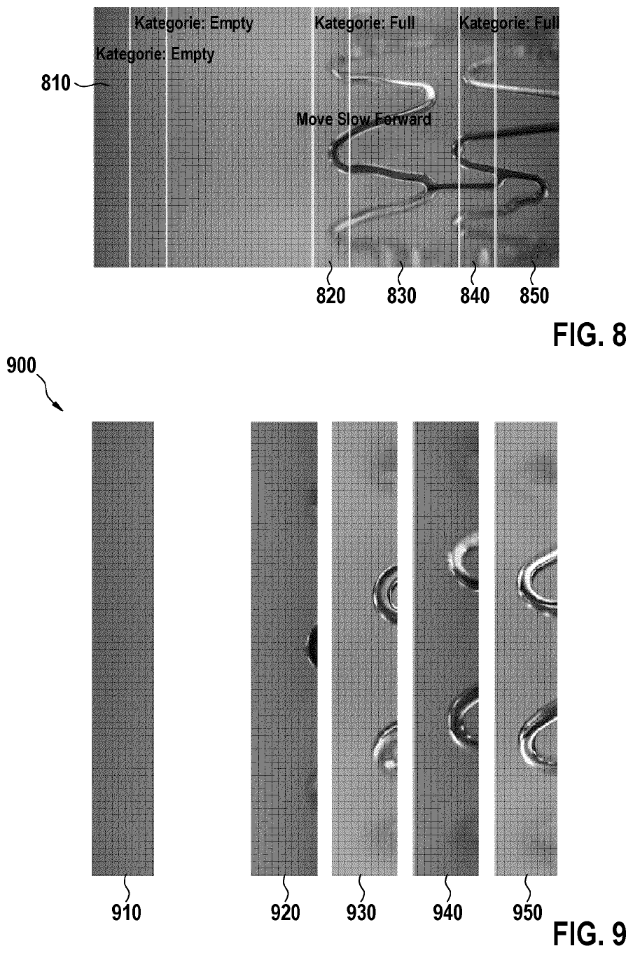

In some examples, the synergetic interplay of the motion system 610 and the camera system 620 can allow a capturing of a video feed while rotating and/or moving the stent 640 within a field of view of the camera system 620 (e.g., as depicted in FIGS. 7A-7C). This can advantageously support a real-time inspection of the stent 640.

To save inspection time and manual inspection steps by an operator multiple stents can be loaded to the motion system 610 for one inspection run. Due to different possible stent lengths, the position of the stent ends can be different for each inspection. Therefore, a software solution can be needed to detect the stent ends. This can be done with the Obtaining Posture Information (110).

In some examples, the aforementioned AI-based stent inspection can support a manual stent inspection, in which the stent inspection process can simultaneously be accompanied by an operator by evaluating the output of camera system 620 on the PC, a monitor and/or by a microscope. If a potential anomaly is detected in a currently obtained image of the stent 640, an acoustic signal can be provided to the operator such as to attract the attention of the operator. At the same time, if a monitor is used, the respective location can be highlighted in the image.

A typical drawback present during a conventional stent inspection arises from the curved surface of a stent and the relatively high magnification used to inspect a certain area of a stent. This combination can often lead to disturbing reflections originating on an outer wall of a stent which can be a source of error, especially during manual inspection. If the stent inspection is based at least in part on a trained AI engine, an extra class can be trained which accounts for these illumination artifacts, ignores them or classifies them as non-critical when detecting such anomalies.

FIGS. 7A-7C exemplarily depict a sequence of a field of view (including a stent) when the translation stage 650 is moved from left to right.

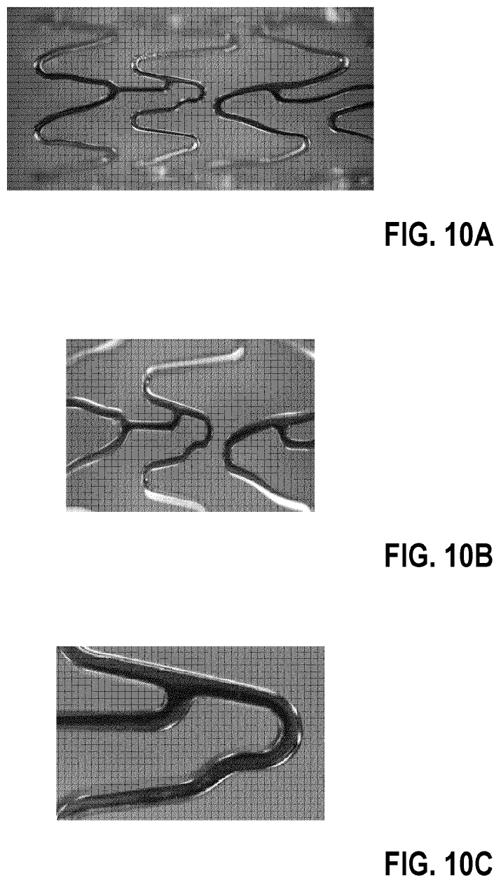

FIG. 8 shows an image 800 of a stent within the field of view of a camera system of a stent inspection device (e.g., the camera system 620 of the stent inspection device 600) for determining a location of a stent within the stent inspection device.

More specifically, FIG. 8 depicts an exemplary image 800 (e.g., a current live image) of a stent (e.g., obtained by the camera system 620) placed in a stent inspection device 600. To determine the location of a stent in the image 800, the image 800 can be segmented into several (predefined) stripes 810-860 (however, any different suitable number can also be possible). The exact location of the stripes can be fixed for all stents and/or can vary.

By way of example, left-most stripe 810 exemplarily depicts a stripe which is considered empty (i.e., a stent is absent, “empty”). The four stripes 820, 830, 840 and 850 relate to four exemplary classes for classifying the positioning of a stent (“full”).

To determine/control the location of the stent in the image 800, it is possible to use a (trained) Convolutional Neural Network (CNN) classifier. Each of the aforementioned stripes can be cut out of image 800 and individually passed to the classifier. For each inspected stripe, the classifier can assign the respective stripe to one of the classes “full” or “empty”, which means that two classes are required for determining a location of a stent within the field of view of camera system 620 (trainable by a binary model, wherein only individual stripes with or without a stent can be used for training).

The resolution of the stripes can be 100×720 pixel, but the width of the stripes could differ depending on the needed accuracy of positioning. Also, a resolution of 1×720 Pixel can be possible, which relates to just one-pixel line across the hole image.

If different stripes are passed through the CNN, an exact position of the stent can be obtained, and it can be derivable whether it is the left or the right end of the stent which is depicted in the respective stripe.

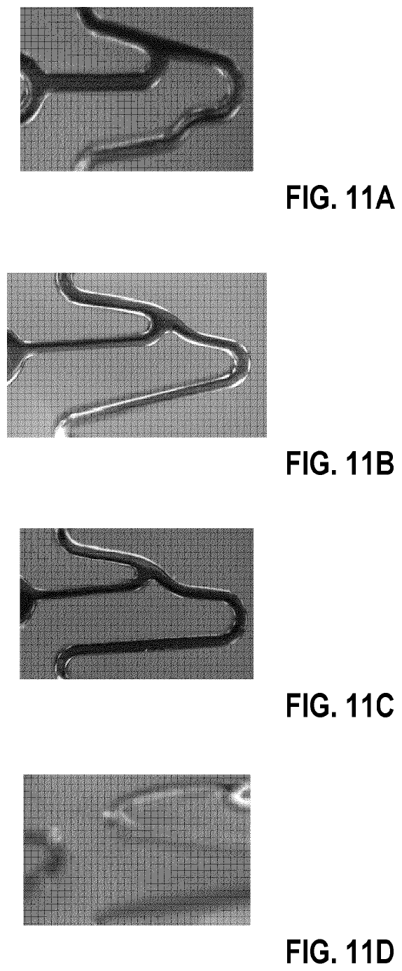

FIG. 9 shows five exemplary stripes 910, 920, 930, 940 and 950 representing the classes “empty” (910) and “full” (920, 930, 940 and 950) in more detail

An exemplary architecture which can be used for training the classifier model for determining a position and/or orientation of a stent is given in Table 1, below. The model can include an input layer, 8 hidden layers and an output layer. The first six layers can be a three-dimensional tensor with the information height, width, and channels. The input layer is adapted to process an input array of dimension 180×25×3 wherein 180×25 refers to the input image size (reduced from an original resolution of 720×100 pixels) and 3 to the color channels of the RGB values. The width and height dimensions tend to shrink when going deeper into the CNN. And by going deeper into the CNN, more output channels are given to the layer (45, 6, 64).

TABLE 1
exemplary sequential CNN model used
for determining a posture of a stent

| Layer (type) | Output Shape |
|---|---|
| Conv2d (Conv2D) | (None, 180, 25, 32) |
| Max_pooling2d (MaxPooling 2D) | (None, 90, 12, 32) |
| Dropout (Dropout) | (None, 90, 12, 32) |
| Conv2d_1 (Conv2D) | (None, 90, 12, 64) |
| Max_pooling2d_1 (MaxPooling2) | (None, 45, 6, 64) |
| Dropout_1 (Dropout) | (None, 45, 6, 64) |
| Flatten (Flatten) | (None, 17280) |
| Dense (Dense) | (None, 256) |
| Dropout_2 (Dropout) | (None, 256) |
| Dense_1 (dense) | (None, 1) |

Towards the output layer of the CNN, the 3D representation of the data processed by the architecture can be flattened to a 1D vector. After flattening, a 1D dense layer could be used to perform the classification. In this CNN two dense layers can be used to ensure that the output of the CNN corresponds to the number of classes equal to 1. In the exemplary case as described above, only two classes are present the model needs to be trained on with a binary class mode. As a result, the output layer has just a dimension of 1.

At three locations in the exemplary CNN a dropout is used to avoid overfitting. Therefore, the number of interconnecting neurons is randomly reduced.

Exemplary training parameters which can be used for training a CNN for classifying an image data set such that a location and/or orientation of a stent can be facilitated are, e.g., a batch size of 10, class_mode: binary, optimizer, Adam, learning rate: 0.001, epochs: 50 and data augmentation by a horizontal flip.

The method of determining a stent location can further also include determining an orientation of a stent.

As described with reference to FIG. 1, above, subsequent to the determining of a location and/or orientation of the stent in a stent inspection device (e.g., the stent inspection device 600), a stent type detection can follow.

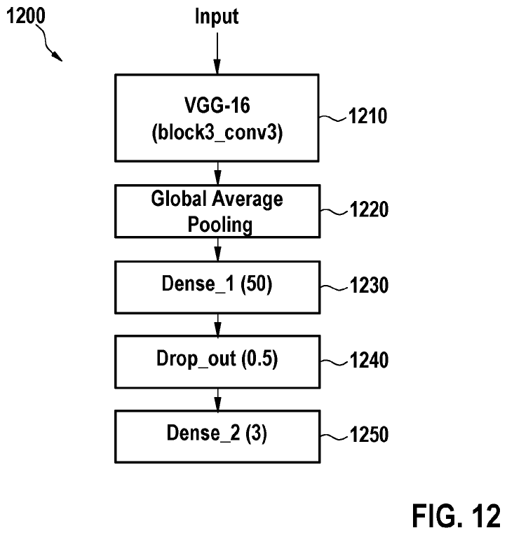

The determining of a stent type will be described with reference to FIGS. 10-12, below.

The determining of a stent type can be based on a sole visual inspection of the stent. The visual inspection can be based on an AI based classification of image data provided to a respective trained AI engine, e.g., the AI engine as described herein. In some examples, the determining of a certain type of a stent can include determining a size of a certain stent. In such an example, the visual inspection can be configured for associating a stent with one of, e.g., three predefined classes, each related to the size of the stent: S, M and L. Each of the stent types can have a unique pattern with respect to its mesh and each stent can be affiliated with at least one predetermined class.

FIGS. 10A-10C show exemplary image data sets (e.g., the image data set as described above, e.g. for determining the stent position, and/or a new image data set expressly supplied for the classification of a stent type).

A first step of the classification process can include a pre-processing of a respective input image data set. In an example, original images included by an image data set can be taken with a resolution of 1280×720 pixel for said purpose, e.g., as exemplarily shown in FIG. 10A. In some examples, a smaller region can be cropped out from these images which can contain a pattern of the stent (e.g., a mesh pattern) that can be unique to a certain class.

FIGS. 10B and 10C exemplarily show two different zoom settings that can be used for a classification of the stent type (e.g., a size of the stent) wherein a final zoom according to FIG. 10C can be chosen due to its capability of providing a detailed description of a stent.

By way of example, the classes which can be associated with a certain stent type can not be limited to the three aforementioned classes directed to a size of a stent (or generically the type, e.g. product name, of a stent). When a multi-class classifier is used, the respective classifier can be trained for the classification of two additional classes: invalid (which can refer to random parts of the stent (“blurry”)) and wrong diameter (which can relate to blurry and/or out of focus parts (“blurry”) depicted in an image of the image data set).

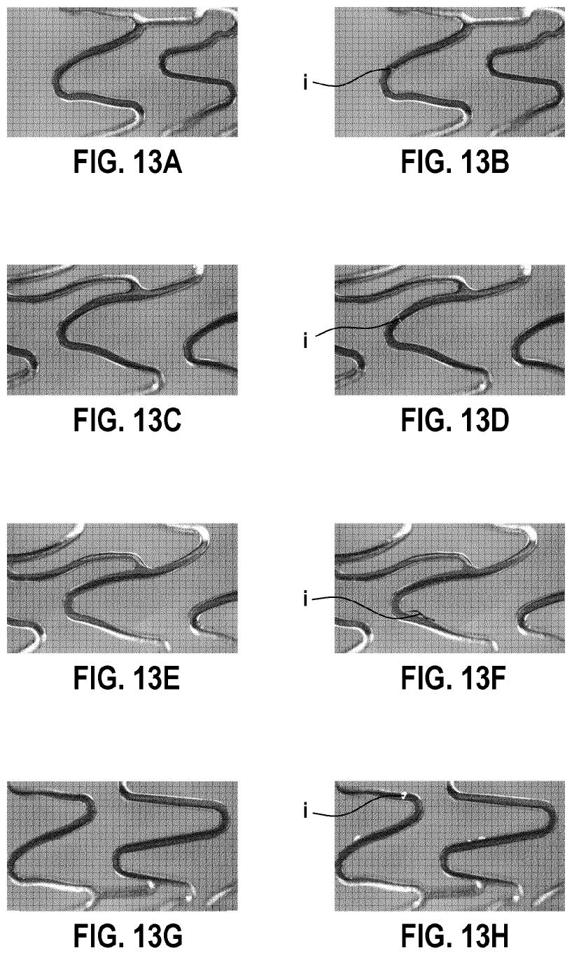

One example of each of said classes is shown in FIGS. 11A-11F. More specifically, FIG. 11A-11C exemplarily show stents of different sizes. Notably, FIG. 11A shows a stent of type T6S, 11B shows a stent of type T6M, FIG. 11C shows a stent of type T6L, FIG. 11D shows an image of a stent wherein the stent has been out of focus.

The image data used for associating a certain image of a stent with a predefined class directed to the size of the stent and the image data used for associating a stent with a class directed to an “invalid” and/or “blurry” image of a stent can be the same or can at least partially be different from each other (e.g., the image data set used for associating a stent with a size can at least partially differ from an image data set used for associating an image with the classes “invalid” and/or “blurry).

In the following, an exemplary network architecture and an associated training is discussed. Generally, there is a wide variety of existing classifiers such as VGG-16, ResNet, EfficientNet, MobileNet etc.

In an exemplary case, a pretrained VGG-16 can be selected. Said model can be available pretrained on the ImageNet dataset available in different frameworks. As an example, the multi-class classifier for the stent type can be trained in Keras/TensorFlow. The layers of pre-trained VGG-16 that can be used in the classifier can be frozen, which means that pre-calculated weight values can be used. This can be done by setting the trainable parameter to “False” during the creation of the model. As the ImageNet dataset contains more than 1000 categories from various aspects of life, the pretrained VGG-16 model can be able to generalize and learn features from these available categories. In addition, earlier layers of a neural network can all learn similar basic features including horizontal and vertical edges. This reduces the training time of training the network from scratch and can allow the model to learn much faster and better. The multi-class classifier can be trained with the following parameters (e.g., when implemented in TensorFlow): learning rate=0.0001, decay=0.000009, batch size=32, optimizer=Adam, loss function=categorical cross entropy.

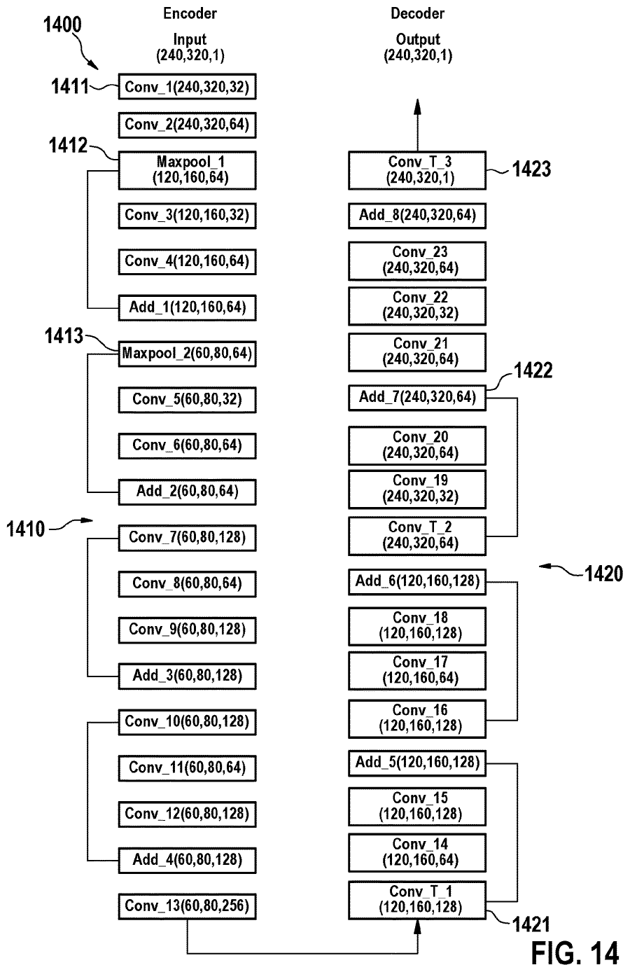

The association of a stent with a class can be based on using a multiclass classifier. FIG. 12 exemplarily shows an architecture 1200 of a multi-class classifier as it can be used for determining a stent type. The original pre-trained and pre-implemented VGG-16 model 1210 can be used up to the layer titled ‘block3_conv3’. The output of this layer can be passed onto the layers that can be customized for the identification of the stent type. The VGG-16 layers can be frozen with the trainable parameter set as False.

More specifically, VGG-16 layer 1210 can be followed by a global average pooling layer 1220, followed by a first dense layer 1230. Subsequently, the output of the first dense layer 1230 (providing an output of 50 nodes) can be provided to drop_out layer 1240 (with a probability 0.5 for dropping a node) which can be followed by a second dense layer 1250 (providing an output of three nodes).

The layers 1220-1250 arranged subsequently to the VGG-16 model 1210 can all be trainable and can adjust their weights during training to find the best values that will accurately identify the stent type.

The last layer of the architecture 1200 is provided with a number of nodes equal to the number of total classes which shall be supported. The final output vector can provide three probabilities indicating a likelihood with which an image data set provided to the architecture 1200 can be affiliated with a certain predefined class. The highest probability can be selected as a prediction of the assignment of the respective image data set to a certain class.

If the multi-class classifier identifies the class as either invalid or wrong diameter, a stent inspection device used for inspecting/classifying a stent can be given the command to skip the entire stent and move on to the next stent. The failure detection part of the visual inspection can only be called if the stent type S can be identified by the classifier.

An exemplary training data can include RGB images, which can all be resized to the same size (160, 250, 3); where 3 represents the number of (color) channels (e.g., RGB). The multiclass classifier can be trained separately for S, L and M classes. In the present example, a classifier for stent type S can be developed, which means that it can only include three classes: S, invalid and wrong diameter. The training data can further include 1515 images; 435 images for class S, 836 images for class invalid and 244 images for class wrong diameter.

A multi-classifier of different design classes can also be trained, with focused and unfocused (“blurry”) images per class, that the class can be predicted in any image condition and a second classifier or image analyzer analyzes the focus of the image in (e.g. good focused, enough focused or bad focused). In this way more detailed information can be presented to an operator or to an inspection system, for skipping the stent or refocusing the camera etc.

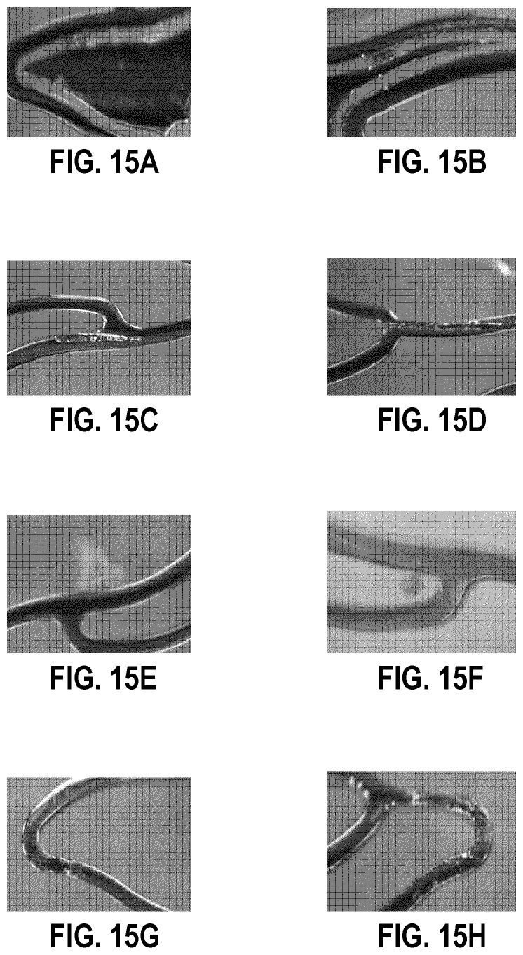

In the following, and with reference to FIGS. 13A-18C, a classifying of a stent, potentially including an anomaly, can be described. The classifying can preferably be executed in a two-step failure detection method including a processing of an image data set (e.g., input image data set 210) by a denoising autoencoder (e.g., the denoising autoencoder 220) and a processing, based on the output of the denoising autoencoder, by a subsequently arranged multiclass classifier (e.g., the multiclass classifier 270).

As outlined above, before using the denoising autoencoder, a training of the denoising autoencoder is required. The autoencoder training data set can include an image data set including original images that can be taken from different parts of stents without any failures or defects. The total number of images taken can, e.g., be 1500 with different resolutions ranging between 2560×1920 pixel to 800×600 pixel. All of said original images can be taken with three channels in RGB format.

An anomaly can then be artificially added to the original images using an image processing software. The goal can be seen in mimicking an anomaly as close to real world failures of a stent as possible.

More specifically, FIGS. 13A, 13C, 13E and 13G exemplarily depict original images (no anomaly has been added). These original images can be taken as label image data sets for training the autoencoder 220 whereas FIGS. 13B, 13D, 13F and 13H show exemplary images after an anomaly was added to the respective corresponding original image.

More specifically, FIG. 13B corresponds to FIG. 13A whereas a material anomaly i has been added to the material of the depicted stent. FIG. 13D corresponds to FIG. 13C whereas a material anomaly i has been added to the material of the depicted stent. FIG. 13F corresponds to FIG. 13E whereas a fibre i (acting as an anomaly) has been added as a deposition on the stent as depicted in FIG. 13F. FIG. 13H corresponds to FIG. 13G whereas a particle has been added as a deposition on the stent as depicted in FIG. 13G.

It is noted that it can not be necessary to recreate every potentially existing failure for training the denoising autoencoder 220 without affecting the reliability of the denoising autoencoder 220 in removing a large amount of anomalies of any kind and present the region of interest.

Before the images can be fed to the denoising autoencoder 220, the following pre-processing can be applied to each input image data set: image resizing: width=320, height=240; grayscale conversion: channels=1; normalization: pixel values normalized between 0 and 1.

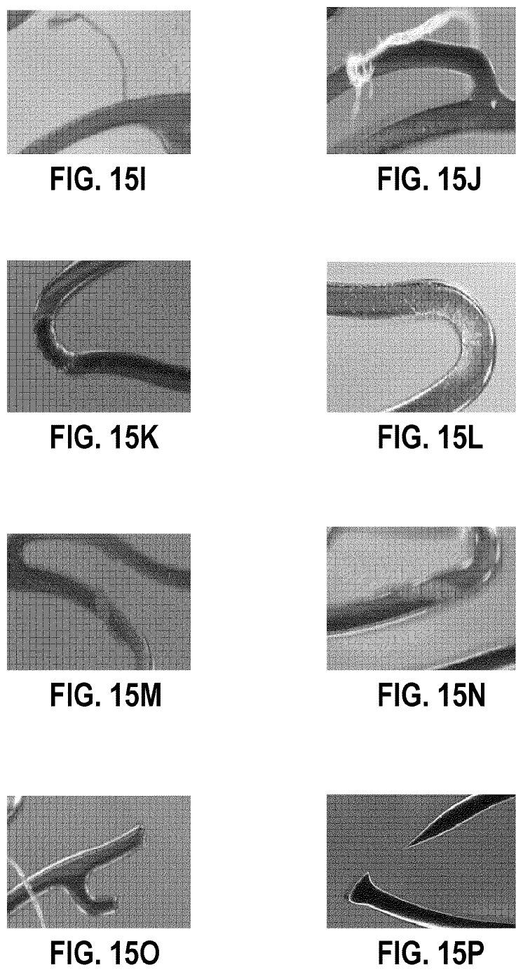

An exemplary architecture 1400 of the denoising autoencoder 220 is shown in FIG. 14. The architecture 1400 is based on residual connections in a ResNet-50 architecture. However, the architecture 1400 can independently be created with layers suited for a specific image data set to be classified. The exemplary architecture 1400 includes an encoder 1410 and a subsequently arranged decoder 1420.

More specifically, the left side of FIG. 14 shows the encoder 1410 which can be configured to receive an image of size (240, 320, 1) at its input. As the input image passes through the convolutional layers, its dimensions (e.g., the extent to which certain features are represented) can change. The number of channels can depend on the number of filters used in each convolutional layer. For example, the first convolutional layer (Conv_1) 1411 can use 32 filters, extracting 32 different features from the input image. This can change the image shape to (240, 320, 32), where the width and the height can remain unchanged: 320 and 240, respectively. The width and the height of the images can be changed after passing through the max pooling layers.

As the image passes through the successive layers of the architecture 1400 it can get down-sampled using “maxpooling” layers 1412 and 1413. The purpose of down sampling can be seen in reducing the size of the feature vector, which can in turn reduce the number of calculations and can accelerate the training process. It can also help in allowing the architecture to identify the class from a small number of pixels available.

The output of the encoder 1410 can be passed to the decoder 1420 which can use transposed convolution layers 1421, 1422 and 1423 to upsample the feature vector (increase the size of the vector). In addition, normal convolution layers are also used to extract features and reconstruct the image back to its original size. The output of the decoder can be an image with an anomaly which can have been present in the image input into the encoder 140 completely or partially removed.

The model can be trained with the following parameters: learning rate=0.0001, decay=0.000009, batch size=32, loss function=mean squared error, optimizer=Adam.

In the following, the training of a multi-class classifier (e.g., the multi-class classifier 270 as described, above) will be described in more detail.

An AI training data set used to train the multi-class classifier 270 can include one or more image data sets which can have been taken manually from a large number of stents including at least one defect. The original width of each input image can be 1280×720 pixel and can depict at least a portion of a stent to be inspected. Each or at least some of the original images can include a defect in at least a small area of the image, which can be cropped out of the original image. Therefore, each of the portions cropped out of the image can depict a localized area of a stent and can depict a defect. In other words, training image data sets provided to the AI engine to be trained can at least partially (or exclusively) include images which only show a defective area of a stent. In some examples, it can also be possible that the training image data sets include images of at least a portion of the stent to be inspected wherein no portions have been cropped out.

The cropped out portions can vary in resolution and can later be resized to be of the same size. The images can not be used with their original resolution as this would result in long training times and would require a large amount of resources. To reduce the training time and allow the use of a realistic GPU, the input image size can thus be reduced to meet the following parameters: input image width=240 pixels, input image height=180 pixels, input channels=3. This can be done for each input image before it can be fed to the AI engine. The total number of training images can be 2055, wherein each of the predefined classes can be assigned with the following number of images:

TABLE 2
overview of exemplary classes a multi-class classifier can
be trained on and an exemplary number of images that can
be used for training associated with each of the classes.

| Category | No. of Images |
|---|---|
| sacrificial piece | 147 |
| material | 369 |
| particle | 203 |
| polish | 225 |
| fibre | 201 |
| rollover | 273 |
| contamination | 192 |
| good | 445 |
| | Total: 2055 |

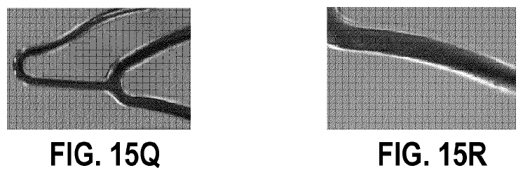

Examples of images to be understood as representatives of the error classes a multi-class classifier can be trained on are exemplarily depicted in FIGS. 15A-15R.

More specifically, FIGS. 15A and 15B show examples of sacrificial pieces, FIGS. 15C and 15D show exemplary representatives of the class “material”, FIGS. 15E and 15F show an exemplary representative of the class “particle”, FIGS. 15G and 15H show exemplary representatives of the class “polish”, FIGS. 15I and 15J show exemplary representatives of the class “fibre”, FIGS. 15K and 15L show exemplary representatives of the class “rollover”, FIGS. 15M and 15N show exemplary representatives of the class “contamination”, FIGS. 15O and 15P show exemplary representatives of the class “open end” and FIGS. 15Q and 15R show exemplary representatives of the “class good”.

Such an image data set can, e.g., be created based at least in part on data augmentation techniques such as horizontal flip and increasing brightness (and/or any other data augmentation technique) of originally captured images to increase the total number of image data sets included to be used for training the AI engine.

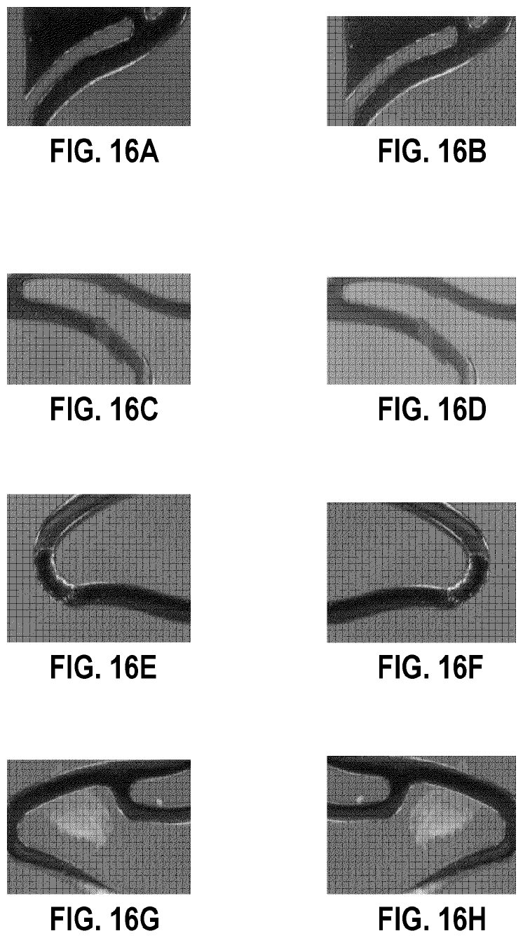

Examples of how a number of items in an original AI training data set can artificially be increased are shown in FIGS. 16A-16H. In this regard, FIGS. 16A, 16C, 16E and 16G show respective original images whereas FIGS. 16B, 16D, 16F and 16H show the augmented images corresponding to the aforementioned original images.

More specifically, FIGS. 16B and 16D correspond to images 16A and 16C, respectively, wherein additional brightness has been added. FIGS. 16F and 16H correspond to FIGS. 16E and 16G, wherein the original image has been horizontally flipped.

An exemplary model used for training a multi-class classifier can be based, e.g., on the pretrained Resnet-50. It is available in Keras and pretrained on an ImageNet dataset. The layers of pre-trained Resnet-50 that can be used can be frozen. Frozen layers can be understood as values which do not participate in a training process, i.e., current (and/or pre-calculated) weight values of nodes included by the frozen layer are set fixed/constant and can not be altered by the training process.

The pretrained Resnet-50 can be based on the ImageNet dataset which can contain more than 1000 categories from various aspects of life. Due to the diversity of the training data set used for training Resnet-50 and the resulting generic training of the Resnet-50 model, the pretrained Resnet-50 model can be adapted to associate a wide variety of test image data sets with at least one predefined class.

In some examples, the pretrained Resnet-50 can further be trained for the classification of stents according to aspects of the present invention. This can be based on further presenting the pretrained Resnet-50 pairs of input image data sets and respective label data. This can reduce the overall training time of the AI engine (e.g., included by multiclass classifier 2470) as the learning process can not be initiated from scratch. This can allow the AI engine to learn much faster and with higher precession. The multi-class classifier can be trained with the following parameters: learning rate=0.00001, decay=0.000009, batch size=32, optimizer=Adam and loss function=Categorical Cross Entropy.

In addition, class weights can additionally be added to account for imbalanced datasets arising from the aspect that some categories can include more images as compared to other. Due to this imbalance in the categories, the AI engine can be inclined to learn the majority classes more and ignore the minority classes. This could lead to a higher overall accuracy because the AI engine can make more correct predictions of the highly available images correctly and false predictions for less available images. As a result, the AI engine can only learn to identify the majority classes. However, for the task at hand, all the classes can be equally important as they can directly impact the product quality.

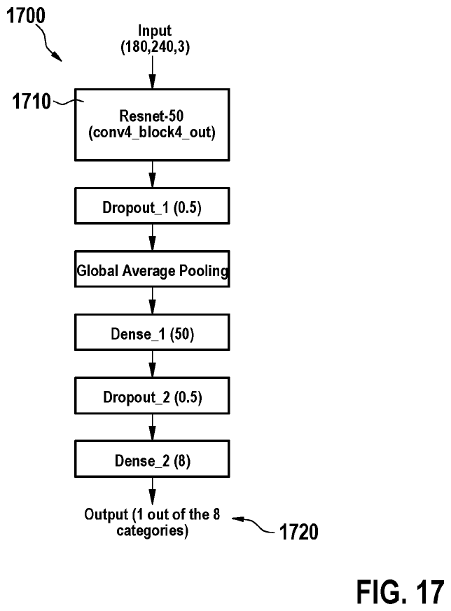

FIG. 17 shows an exemplary architecture 1700 of a multi-class classifier according to an aspect of the present invention. Original pre-trained Reset-50 model 1210 can be used up to layer titled “con4_block4” included therein. The output of this layer can be passed to the layers that are customized for the anomaly (e.g., the defect) detection of a stent. The Reset-50 layers that are represented by block 1710 are frozen with respective trainable parameter set to “False”. The layers subsequent to block 1710 can all be trainable and can adjust their weights during training to find the best values that will accurately identify potential anomalies in an image data set provided to the respective trained AI engine. The last layer 1720 of the architecture 1700 can be configured to include a number of nodes equal to the number of total defect classes (e.g., the classes discussed with reference to Tab. 2, above). As shown previously, the multi-class classifier can identify seven different failure classes and one non-failure class resulting in eight different classes (in some exemplary cases, an additional failure class “open end” (see FIGS. 15O and 15P, above) can be added to the failure classes thus arriving at a total of eight different failure classes). The respective output of architecture 1700 can be a vector which can be configured to possess eight values, each value indicating a probability that an image data set can be a representative of a certain class. The entry with the highest probability can finally be selected and the image data set can be identified as a representative of the class represented by said highest provability value.

In the following, an exemplary object detection procedure is described which can be used to find anomalies (e.g., defects) on a stent. This can be based on ObjectDetection. Object detection can be understood as a simultaneous localization and classification of different objects in a frame. Depending on the needs for the special detection task it can be possible to choose between various different architectures of ObjectDetectors, wherein the most common ones are Yolo, SSD, R-CNN. Important requirements which need to be fulfilled are accuracy vs. speed and/or big objects vs. little objects. Different open source software platforms, libraries or APIs are available for said purpose such as pytorch or tensorflow.

For implementing the classification of the ObjectDetection, TensorFlow can be chosen. Tensorflow, inter alia, provides pretrained models, which are pretrained on the coco dataset. The coco dataset contains more then 200k labeled images in 80 object categories.

To detect objects on a stent, the faster-RCNN architecture can be chosen, because it has a very good accuracy for little objects, however, also other architecture can be suitable for this purpose. Due to the fact that pretrained models are used, the architecture can be somewhat fixed and not interchangeable.

To train an individual object detector, it is recommended to take a suitable pretrained model and train it with a dedicated training data set including representatives of at least those classes with which a trained AI engine is intended to affiliate image data with. Important parameters for the successful training of a faster-RCNN model can be the choice of trainable data, number of classes, distinguishing feature of the classes, data augmentation, image resize for model input, anchor generator, etc.

To set up the unique model for a stent inspection, more than 2200 images can be taken in different resolutions, magnification and with different camera systems. With data augmentation the training input could be varied and increased without providing more labeled data (e.g., labeled raw image data sets). With data augmentation different problems can be addressed, such as: improve model prediction accuracy by adding more training data, reduce chances of overfitting and producing variability in data, it can help to resolve class imbalance problems in classification, it can reduce time and effort of collecting and labelling data.

For the training the model for stent inspection, the following data augmentation techniques can be used: horizontal flip, vertical flip, adjust brightness, image scale and/or color to gray scale conversion.

By resizing the images used for training, it can be assured that all images can have the same input size, wherein the aspect ratio can be maintained when decreasing the size of an image. In a preferred embodiment, a desired size of the smaller image dimension can be chosen to be 600 pixels whereas the desired size of the larger image dimension can be 1024 pixel. In some cases, an image can be padded with zeros such that the output spatial size can be between 600 and 1024 pixel. The zeros can be padded to the bottom and the right of the resized image.

To localize objects in the image, the respective image can be scanned with anchor boxes. The definition of the anchor boxes can depend on one or more of the smallest object to find, the largest object to find and/or the shape of the objects boxes (small×wide, high×thin, square). Exemplary parameter values for describing the anchor boxes can be height_stride: 16, width_stride: 16 (wherein stride can be related to the gap (e.g., in pixel) between two adjacent anchor box positions), scales: [0.25, 0.5, 1.0, 2.0], aspect_ratios: [0.5, 1.0, 2.0].

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A computer-implemented method for training an artificial intelligence (AI) engine for classifying a stent, comprising:
providing a plurality of AI engine training data sets, wherein each AI engine training data set comprises a training image data set associated with a stent and label data associated with the training image data set, wherein the label data indicates at least one of a plurality of predetermined classes, wherein the training image data set of at least a subset of the AI engine training data set is based at least in part on a decoded image data set output by an autoencoder trained for detecting a defect of the stent;
assigning, by the AI engine, at least one of the plurality of predetermined classes to each training image data set;
adjusting the AI engine based at least in part on a comparison, for each of the plurality of AI engine training data sets, of the at least one class assigned to the training image data set of the AI engine training data set with the label data of the AI engine training data set; and
training the autoencoder based at least on the following steps:
providing a plurality of autoencoder training data sets, wherein each autoencoder training data set comprises a training input image data set associated with a stent, wherein the providing comprises altering raw image data associated with the stent;
providing, by the autoencoder, a decoded image data set output based on each training input image data set; and
adjusting the autoencoder based at least in part on the decoded image data set outputs, wherein the adjusting comprises comparing the decoded image data set outputs with the corresponding raw image data.

2. The computer-implemented method according to claim 1, further comprising preprocessing and/or augmenting the training image data sets of at least a portion of the AI engine training data sets prior to the step of assigning at least one of the plurality of predetermined classes to each training image data set.

3. A computer-implemented method for classifying a stent, comprising:
receiving, by an AI engine trained according to one of claim 1, a test image data set associated with a stent,
determining, by the AI engine, an assignment value indicating a relationship between the test image data set and at least one of the plurality of predetermined classes the AI engine has been trained with.

4. The computer-implemented method according claim 1, wherein the plurality of predetermined classes comprises at least one stent type and/or at least one defect type and/or at least one posture indicator.

5. The computer-implemented method according to claim 4, wherein the posture indicator is associated with an orientation of the stent relative to means for inspecting a stent.

6. The computer-implemented method according to claim 3, wherein the training image data set and/or the test image data set associated with a stent comprises at least one video sequence of the stent.

7. The computer-implemented method according to claim 3, wherein the test image data set is based on output image data of an autoencoder trained according to claim 4.

8. The computer-implemented method according to claim 3, wherein the test image data set is obtained in real time.

9. The computer-implemented method according to claim 3, comprising no calibration step.

10. An apparatus for inspecting a stent, comprising:
means for accommodating the stent and rotating the stent about its longitudinal axis comprising two rollers parallel to each other and horizontally separated from each other extending along a longitudinal direction;
means for capturing a test image data set associated with the stent;
computer means for executing the method according to claim 6.

11. A data-processing system comprising means for executing the method according to claim 1.

12. A computer program having instructions which when executed cause a computing device or system to perform a method according to claim 1.
